(19) United States
(12) Patent Application Publication
(10) Pub. No.: US 2007/0234919 A1
(43) Pub. Date: Oct. 11, 2007

(54) Method and Dvice for Combined Printing

(76) Inventor: Kurt Lappe, Neuss (DE)

Correspondence Address: HARNESS, DICKEY & PIERCE, P.L.C., P.O. BOX 828, BLOOMFIELD HILLS, MI, 48303, US

(21) Appl. No.: 10/579,278

(22) PCT Filed: Nov. 10, 2004
(86) PCT No.: PCT/EP04/12676

§ 371 Date: Feb. 13, 2007

(30) Foreign Application Priority Data
Nov. 14, 2003 (EP) 03026230.7

(51) Int. Cl. B41F 19/06

(52) U.S. Cl. 101/488; 101/483

(57) ABSTRACT

The invention relates to a method and to a device for the production of printed products which are printed according to various methods. The invention also relates to a method for the production of printed products by combining various immediately successive processing steps, in order to provide a printing method and a device which enables various methods to be used on the same printed products in immediately successive working steps. The printed products, which are produced in one of the steps of the method in a film printing method, are coated with a film (10) in predetermined positions and are provided with a structure and or are stamped in another step of the method in a structure method and/or stamping method. The printed products to be produced undergo the steps of the method without intermediate storage.

The present invention relates to a method and to a device for the production of printed products, which are printed according to various methods.

Printing devices are known as such and are used to a great extend. Herein, printing base materials, i.e. paper, cardboard, foils in the form of sheets or rolls are passed through roller/cylinder gaps along inking units. In the inking units, ink is respectively transferred to the surface of the printing base material according to different transfer methods. These methods comprise for example offset printing, serigraphy and the like.

Furthermore, film printing methods are known from the state of the art. Herein, all film printing methods have in common that a film is partially applied under pressure and permanently fixed on a printing base material, such as for example paper, cardboard or foil in the form of sheets or rolls. As printing films, in particular films with golden or silvery luster, for example so called transfer films, are used, but differently coloured printing films having mirror polish or silk gloss surfaces are also known.

The printing film is mostly applied to the base material by means of the film relief print technique. This printing technique is similar, in the basic form thereof, to a high printing method (Hochdruckverfahren) and is in so far similar to the letterpress printing. The decisive common characteristic is that the printing parts of the printing form are placed on a higher level than the non printing parts which surround them. During the printing operation the printing form is indirectly heated and maintained at a constant temperature. The printing medium, which is transferred during the printing operation from the printing film to the base material, consists of a printing film layer in form of a thin multilayer dry film, which is detachably fixed on a mostly transparent carrier foil by means of a parting layer. The printing film layer itself has a double layer structure with a silver aluminizing as well as a mostly coloured coat of lacquer. This double printing film layer is finally provided with an artificial resin coating that becomes adhesive when being heated.

In the printing operation, the printing film, together with the base material to be printed, is passed through the printing couple, wherein due to the contact pressure of the heated printing form at the places determined by the raised elements of the printing form the printing film layer is detached from the carrier foil and transferred to the base material. Due to the heat transmitted by the printing form, the parting layer between the carrier foil and the printing film layer evaporates on the one hand, such that the latter one is easily detached from the carrier foil. On the other hand, under the heat effect the artificial resin layer is activated from a dry state into an adhesive state, such that the artificial resin layer forms an adhesive layer between base material and printing film layer. As a result, the printing film layer, for example in form of a golden shining layer, permanently adheres to the base material at the places pre-determined by the printing form.

It is a drawback of this known film printing method that the manufacture and adjustment of the printing form, i.e. the block, require a very long preparation and setting time. Since the preparation and setting time can come to nearly half of the total production time, the known film printing method is very time consuming in total and thereby related to high production costs. Furthermore, it is usual to heat up the printing form to partially more than 200° C., which leads to very high energy costs.

For overcoming the above mentioned drawbacks, EP 0 578 706 B1 has already proposed a film printing method, in which a transfer film comprising a carrier foil, a transfer layer and a parting layer arranged between carrier foil and transfer layer is applied to a base material to be printed under the influence of pressure, wherein in a process step preceding the film application the surface of the base material is provided with an adhesive layer for the transfer layer at the places provided for applying the film, and in a process step following the film application the base material with the transfer layer fixed thereon by means of the adhesive layer is submitted to a contact pressure that is higher than the pressure force during the film application. These methods are called film transfer methods.

In this film transfer or film printing method, the previous preparation of a printing form, i.e. of a block, can be omitted. The transfer of the transfer film is no more realized by exercising a partial pressure in the area of the raised points of the printing form or the block. On the contrary, already before the process step of the film application, the base material provided for the film printing will be provided with a partial adhesive layer, for example a glue layer, which will then in the printing couple receive the transfer layer from the transfer film at the concerning places. Since the adhesive layer is already present on the base material before the real printing operation, the artificial resin layer which is present in the known transfer films can be omitted. Finally, a heating of the printing surfaces is no more necessary, since no more artificial resin layer on the transfer film has to be heated for obtaining the adhesive effect.

In order to realize a permanent connection between the base material and the transfer layer, the base material with the transfer layer placed thereon will be submitted, in a process step following the film application, i.e. the real printing operation, to a contact pressure which is substantially higher than the pressure force during the film application.

Although the above described film printing method according to EP 0 578 706 B1 has proved to be successful in practice, it is a drawback that a further processing, for example printing, stamping or the like, of the base material provided with the transfer layer cannot be realised in a simple way. It is namely necessary to intermediately store the base material after application of the transfer layer in a separate place, wherein it is previously cut to size, if necessary. Afterwards, the base material provided with a transfer layer is supplied in a separate operation to another processing device, for example a printing device, by means of which a further processing, for example printing of the base material, can be realised. Both the intermediate storage of the base material provided with a transfer layer and the additional step of supplying the base material to another processing device is not only time consuming, but also costly, since it is necessary to work in a very precisely fitting way, such that the following processing step to be realized will be exactly matched for both the base material and the transfer layer applied to the base material. With regard to the following processing step, there had often been divergences and faulty printings in the past, which disadvantageously had led to high refuse, which is very costly, in particular in view of the base material already provided with a transfer layer.

It is the same case if printing base materials to be coated by means of films are pre-treated, for example pre-printed or pre-stamped. Here also a completely separate second operation is required in order to supply the pre-treated printing base materials to the film transfer after final completion of the processing operations including a drying which is possibly required, conditioning or the like.

On the base of the described state of the art it is the object of the invention to provide a printing method and a device which enable various methods to be used for the same printed products in immediately successive working steps.

With regard to the method, for technically achieving this aim the invention proposes a method for the production of printed products by combining various immediately successive processing steps, wherein the printed products to be produced are coated with a film in predetermined positions in one step of the method and are provided with a structure and/or are stamped in another step of the method in a structure method and/or stamping method, wherein the printed products to be produced successively undergo the steps of the method without intermediate storage.

The method according to the invention stands out for its in-line execution of the method. The single steps of the method for the treatment of the base materials are immediately successive steps and can be realised in one continuous sequence. In contrast to the state of the art, it is therefore no more necessary to intermediately store the base material provided with a film or a transfer layer in a separate place, in order to then carry out another working step for a further processing of the base material. The method according to the invention rather permits a continuous execution of the method, the result of which is a base material coated with a transfer film or a transfer layer, which is additionally provided with a structure and/or is stamped. According to the invention, the film printing method and the structure and/or stamping method are thus matched to each other and coupled to each other.

According to a first alternative of the invention it is provided that the printed products to be produced are first coated with a film and then provided with a structure and/or stamped. Alternatively it can be provided that the printed products to be produced are first provided with a structure and/or stamped and are then coated with a film. But in any case, the method according to the invention is carried but in a continuous in-line way, i.e. the film printing method is either immediately preceding or immediately following the structure and stamping operation. An intermediate storage of the printed products to be produced will not be realized.

By stamping in the sense of the invention it is meant that the base material, which might be already coated with a film or not, will be provided with elevations and/or indentations. Herein, the overall impression of the elevations and/or indentations can optionally be an arbitrary pattern. Thus, it is imaginable that all the places of the base material which are coated with a film will be formed as elevations and/or indentations either before or after being coating with the film.

Forming a structure in the sense of the invention means that the base material is provided with a regular pattern of elevations and/or indentations either before or after being coated with a film. Thus, a structure can be for example formed such that the base material is provided with elevations and/or indentations in the form of lines running in longitudinal, transverse or any other direction, which are equally spaced from each other. Other patterns can of course be formed, wherein there is no limit to imagination. It is only decisive that the structuring takes place within a continuous execution of the method.

According to another characteristic of the invention it is provided that in another step of the method the printed products to be produced are printed with colour in a printing step comprising at least one inking unit. Herein, the printed product to be produced can be colour printed before or after being coated with a film and before or after being stamped. According to this alternative of the method the base material which has been previously provided with a film or a transfer layer and with a structure or stamped pattern, can be first dried and thus be prepared for the following printing operation. After the drying, the base material provided with a film or transfer layer and a structure or stamped pattern, is then printed. The result of this execution of the method is a base material provided with a film or transfer layer and with a structure or stamped pattern as well as with an additional printing, which base material can then be cut to size according to the requirements and can be eventually further processed for a desired use. In any case, it is not necessary, in contrast to the state of the art, to carry out the application of the film or transfer layer, the forming of the structure and/or stamping as well as the printing of the base material in individual complex process steps. In so far, the method according to the invention can be carried out in a much simpler way and is also much less costly.

In a modification of the above described alternative of the method it can also be provided that the base material is printed and then dried in a process step which immediately precedes the application of the film or transfer layer. Then, the base material, which has already been printed and provided with a transfer film, will be provided with a structure and/or be stamped. Also this alternative of the method stands out for its in line execution of the method. In contrast to the first mentioned alternative however, it is provided according to this execution of the method that an additional printing of the base material will be realised before the application of a transfer layer or before the step of forming a structure and/or stamping. Herein, it is provided that the base material is first printed in a first process step. Then, the printed base material will be dried in a drying operation. Then, the printed base material will be provided with a film or transfer layer and a structure and/or stamped pattern in the above described way. Of course, it can also be provided herein that the printing operation is first followed by a stamping operation, before the then printed and stamped base material will be provided with a film or transfer layer. The result according to this execution of the method is a base material which comprises a film or transfer layer and is additionally provided with a printing and a structure or stamped pattern. This alternative execution of the method neither requires a multipart realisation of the method, such that the same advantages are achieved as in the previously described first variant of the method.

It goes without saying that it is comprised within the scope of the invention that the order and frequency of the single process steps can be arbitrarily varied. Thus, the base material can first be provided with a stamped pattern, then with a printing and finally with a transfer film. Herein, the printing can be for example a multicolour print, for which the material is printed in a way known in itself from the state of the art in a plurality of inking units/printing couples, respectively with the required steps, such as drying and the like. Herein, it is essential that with regard to the printing or the film printing, the products finished in the respective step of the method are dried to such an extend that the product will be present as intermediate product for a further processing of any kind but still in line, i.e. without any need of intermediate storage. Even if other printing steps follow the coating with the transfer film or other film transfer operations are carried out, the order and frequency of these steps are arbitrary. It is the same for the structure and/or stamping method. However, after a printing operation, a film transfer operation or a structure and/or stamping operation, first the intermediate product status is always set. For this reason it is provided according to another characteristic of the invention that the printed products to be produced are dried in another step of the method, wherein the drying is carried out after the film coating and/or after the colour printing. Herein, as described above, several film coatings and/or several colour printings can be provided, wherein after each film coating and/or after each colour printing a drying has to be realised.

According to another proposal of the invention, the drying operation can be carried out by means of infrared radiation, ventilator blowing and/or such methods. The drying operation is important for the method in so far that the following processing step can be carried out with high accuracy and no faulty execution of the method will happen due to a possibly still humid base material. The ventilator blowing or the infrared radiation has proved especially suitable for the drying operation. Other possibilities of drying are of course also suitable and can be used according to the need of the respective working of the method. However, the mentioned methods stand out for their efficiency with simultaneous minimization of the costs.

According to another proposal of the invention the transfer film to be supplied to the base material within the scope of the execution of the method is supplied to an expander roller equipped with lamella in an additional process step. Hereby it is achieved that the transfer film will be flattened and also stretched in the direction of width, which advantageously permits an improved forming of the printing image conditioned by the transfer layer. According to a special advantage of the invention it is provided herein that the expander roller is shorter than the width of the film transfer unit. Expander rollers are usually rollers equipped with gummy lamella. These lamella usually point from the centre plane of the roller respectively outwards to the ends of the rollers. This means that material which is guided over these rollers will always be stretched outwards, i.e. in the direction of width, due to the pressure applied by the lamella. If not the complete pressure or transfer width of a device shall be used, an expander roller can be for example used that is asymmetrical. If only half the transfer width is used, the centre will be placed approximately after a quarter of the length of the expander roller, from which centre lamella extend which are respectively inclined towards the end or the centre of the roller. Thus only half a width of a device can be used. The second half of the expander roller can be for example designed without any lamella.

The method according to the invention permits to use a flat, eventually elastic pressure surface for exercising a pressure during the application of the film. The strength of the pressure force during the application of the film should be advantageously dimensioned such that this force is not sufficient for pressing the printing film edges into the base material. However, the pressure force has to be high enough to detach the transfer layer partially or completely from the carrier material.

In order to enable a continuous execution of the film printing method, it is proposed in one embodiment of the method to apply the film between two rollers of a transfer calendar which run in opposite directions. Furthermore it is advantageous to apply the required contact pressure between two rollers running opposite directions, in order to assure a final fixation of the transfer layer.

If according to one embodiment of the method, the base material is provided with the adhesive layer in a single-colour or multicolour inking unit, a commercial printing couple can be used for this part of the method, such that relatively low purchase and operating costs will be incurred. For too highly absorbent base materials the adhesive layer can be covered by a primary coat. For this, especially a two-colour printing couple is suitable. The use of a two-colour printing couple also allows a mixed adhesive to be easily applied as adhesive layer for the transfer film.

For forming a structure and/or stamped pattern, preferably a structure and/or stamping calendar is provided. This calendar has rollers rotating in opposite directions, which are superposed in vertical direction and spaced from each other, wherein the base material to be provided with a structure or a stamped pattern is supplied to the rollers and guided through the roller gap that forms between the rollers. Herein it goes without saying that the gap width between the at least two rollers can be optionally set. Herein, one of the two rollers is provided with a comparatively hard surface, whereas the other roller comprises a comparatively less hard surface and is for example made of an elastic material, for example rubber. The harder one of the two rollers carries the pattern to be stamped into the base material in negative form. The other roller opposite this roller serves as contact pressure roller and presses the base material to be provided with a structure and/or stamped pattern against the stamping roller. The result is a base material provided with a structure or a stamped pattern, which can be provided with a transfer film and/or a printing in the course of the further in-line working of the method, as described above.

According to another characteristic of the invention, it can be provided that the base material is printed with a switching circuit. Such a switching circuit can for example comprise strip conductors that can be used in the following as electronic unit. The application of a switching circuit or multiple switching circuits can take place upstream or downstream of the above described process steps or in-line. There is no limitation here.

According to another characteristic of the invention, the base material can also be provided with safety motives. Safety motives in the sense of the invention can be motives which are not visible in normal conditions, such as for example daylight. These motives become only visible under for example UV radiation. Such safety motives can for example serve as criterion of genuineness. Herein, also the application of safety motives can be realised upstream or downstream of the already above described process steps or in line. For the application of switching circuits and/or safety motives, structure calendars, stamping calendars, stamping couples and printing couples are suitable.

The film printing method has proved especially suitable for in particular forming switching circuits. Herein, a carrier foil provided with copper as transfer layer is used as transfer film. Apart from copper, also other conducting materials can obviously be used. It is only decisive that the printing image formed by means of the film printing reproduces the strip conductors to be applied on the base material for forming the desired switching circuit.

Another principal problem with regard to the described technology results from the structure of the printing cylinders. These ones for example have a standard circumference of 920 mm, wherein only a printing area of 720 mm is available. In the remaining 200 mm, the grippers for the printing films are arranged. In the context of printing cylinders one speaks of the so called channel zone with respect to the mentioned 200 mm, which extend in parallel to the longitudinal axis essentially over the total length of the cylinder. If the described carrier foil provided with the transfer layer continuously rotates around the printing cylinder for the transfer purpose, a dead space of 200 mm results every 720 mm, which dead space cannot be used for transfer purposes. This is after all more than 20%, such that also a corresponding film loss results, since these zones will finally become rubbish. Completely independent from the described solutions, advantages and characteristics, the present invention provides an autonomous solution for this problem. This solution consists in that the method provides to control the film infeed of the transfer film independently from the rotation of the printing cylinder. For this purpose it is provided according to the method that the transfer film is stopped for a short time with respect to the rotation of the printing cylinder and/or even guided in the opposite direction. Advantageously, at least some zones of the transfer film can be lifted from the printing cylinder for the mentioned purpose. The printing cylinder for example then advances over the described 200 mm with respect to the film that has been fixed or even transported back and the channel zone does not necessarily generate film rubbish. This presented solution can be used independently from all other solutions described in the present application, also for transfer units belonging to the state of the art.

With regard to the device, for technically achieving the aim of the initially mentioned object, the invention proposes a device for the production of printed products by combining various immediately successive processing steps, comprising at least one structure and/or stamping calendar as well as at least one film transfer device.

Furthermore, according to another proposal of the invention, a printing device comprising at least one inking unit can be provided, which is connected in series with the film transfer device and the structure and/or stamping calendar.

According to the invention a device which is suitable for carrying out the method is provided comprising at least one structure and/or stamping calendar as well as at least one printing couple, which comprises a transfer film supply, a transfer film carrying-off unit as well as a printing gap that is on the one hand limited by a printing surface and on the other hand by a counter-surface for guiding through a base material to be printed together with the transfer film supplied by the transfer film supply, wherein furthermore are provided: a gluing unit placed upstream the printing couple and comprising a gluing organ, which provides the base material with an adhesive layer, as well as a pressing unit placed downstream the printing couple and comprising a pressing gap, which is on the one hand limited by a pressing surface and on the other hand by a pressing counter-surface, for guiding through the printed base material. This device is completed by a drying device placed downstream the pressing unit and by a printing device placed downstream the drying device. Additionally or alternatively a printing device placed upstream the gluing unit and a drying device interposed between printing device and gluing unit are provided. The structure and/or stamping calendar can be placed either upstream or downstream the printing device or the film transfer device.

The above described variants of the device advantageously enable an in-line execution of the method according to the invention. Herein, according to a first alternative embodiment, it is provided that a drying device is placed upstream or downstream the pressing unit. The purpose of the drying device is to dry the base material provided with a film or transfer layer and thus to prepare it for another processing step. Such a drying can be carried out by means of ventilator blowing or by means of infrared radiation. Following the drying operation, the base material already provided with a film or a transfer layer is printed or stamped, for which purpose a printing device or a structure and/or stamping calendar is placed downstream the drying device. The printing device can be formed by an upper and a lower roller, wherein the upper roller preferably serves for the real printing operation, whereas the lower roller is formed as counter roller of the upper roller, in order to be able to assure a sufficient contact pressure of the upper roller.

According to another alternative of the device it can be provided that the base material, before being provided in the above described manner with a film or transfer layer, is printed in an upstream printing operation and is stamped in a stamping operation downstream the printing operation. For this purpose it is provided that a printing device is placed upstream the gluing unit. Thus, before the base material is provided with an adhesive layer and later on with a film or transfer layer, the base material will be both printed and stamped. In order to assure that after the printing of the base material the adhesive layer can be correctly applied, a drying device is provided between printing device and gluing unit. This drying device provides for a drying of the printed base material before this one will be provided with an adhesive layer in the following. Of course, it is also possible to stamp the base material at first in a stamping operation, then to print it and finally to provide it with a transfer film.

According to a special advantage of the invention, the individual structural components of the film transfer machine are arranged in-line immediately one after the other, which permits an in-line execution of the method with the already described advantages.

According to another characteristic of the invention, an expander roller equipped with lamella is a component of the film transfer machine according to the invention. Herein, according to another characteristic of the invention, the expander roller can be asymmetrical with respect to the lamella arrangement thereof. This means, as described with respect to the method, that the part of the expander roller which is equipped with lamella does not have to extend over the complete length of the expander roller and can be asymmetrically placed with respect to the mid-plane of the roller. In this way, partial widths of the device can be used.

The film transfer machine is thus designed such that the pressing surface and the pressing counter surface are formed by two smooth-faced rollers of a printing calendar. Preferably the printing surface and the counter-surface are also located on smooth-faced rollers, which in this case form a transfer calendar.

In another embodiment the printing couple and the pressing unit form a structural unit, wherein the upstream gluing unit can be a single-colour or multicolour inking unit known in itself.

The single-colour or multicolour inking unit, the printing or transfer unit and the pressing unit form together the film transfer machine enabling an in-line film transfer. It is thus easily possible to place this film transfer machine downstream a continuous printing machine, a web-fed printing press or a label printing machine in the sense of an in-line production. The machine unit composed of printing couple and pressing unit can also be placed as additional unit downstream existing printing couples or adhesive application machines.

With respect to the method, an invention, which is completely independent from all other solutions, advantages and characteristics, with respect to the bridging of the channel zone of the printing cylinder has been described. In order to make the printing cylinder advance with respect to the film, which has been fixed or even been transported back, over at least the region of the channel zone of 200 mm without forward feed of the transfer film, it is proposed with respect to the device to guide the transfer film over so called dancers around the printing cylinder. The dancers are shafts with displaceable axes. A cam control, preferably a barrel cam control and a corresponding drive can be used for at least adjusting one of the used dancers with respect to the film by displacement of the axis, in order to control the tension applied on the transfer film in this way. Thereby it is made possible that the printing cylinder can rotate empty with respect to the transfer film over at least a circumferential zone. Additionally, the transfer film can be guided with respect to the printing cylinder such that it sits closely on the printing cylinder only in the transfer gap, in order to reduce the friction surfaces. Hereby, the forward feed of the film can be nearly arbitrarily controlled with respect to the printing cylinder. These solutions with respect to the device are independent from the above described solutions, advantages and characteristics of the invention and represent an autonomous invention.

Other details and advantages of the subject of the invention will result from the following description of the associated drawings, in which preferred embodiments of the method according to the invention and the device according to the invention are represented. The representations in the drawings do not reproduce the real proportions in size. In detail:

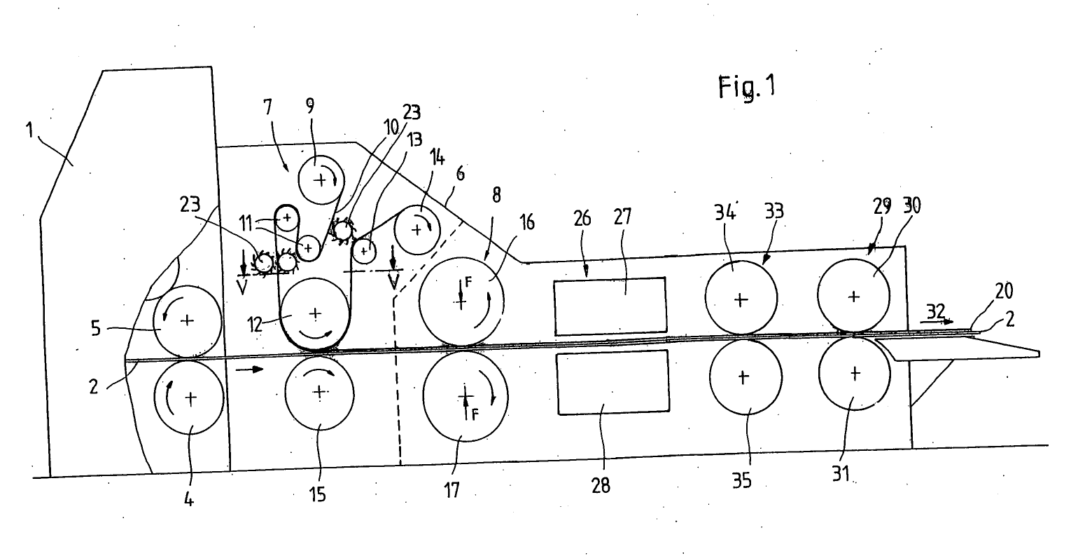

FIG. 1 is a simplified, partially cut side view showing a printing unit according to a first embodiment;

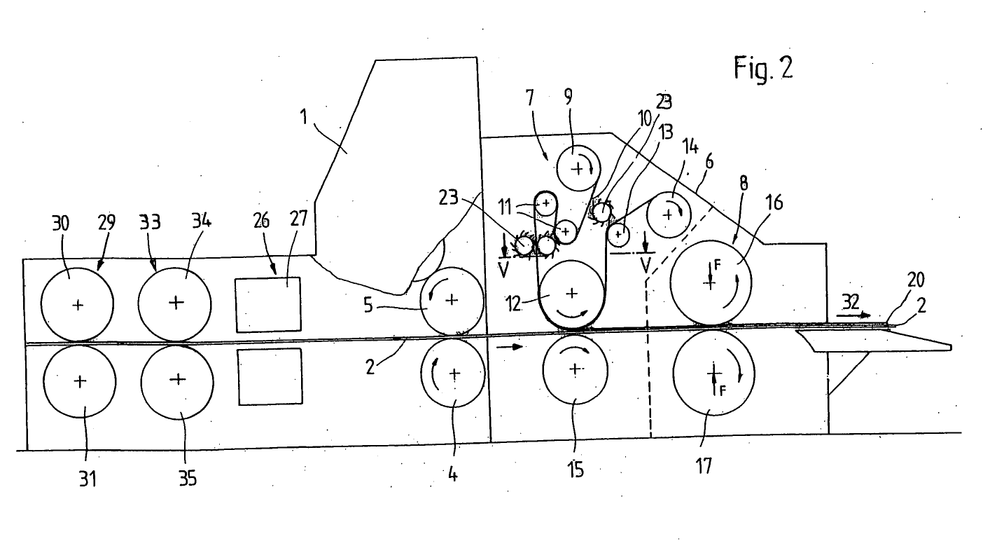

FIG. 2 is a simplified, partially cut side view showing a printing unit that can be integrated according to a second embodiment;

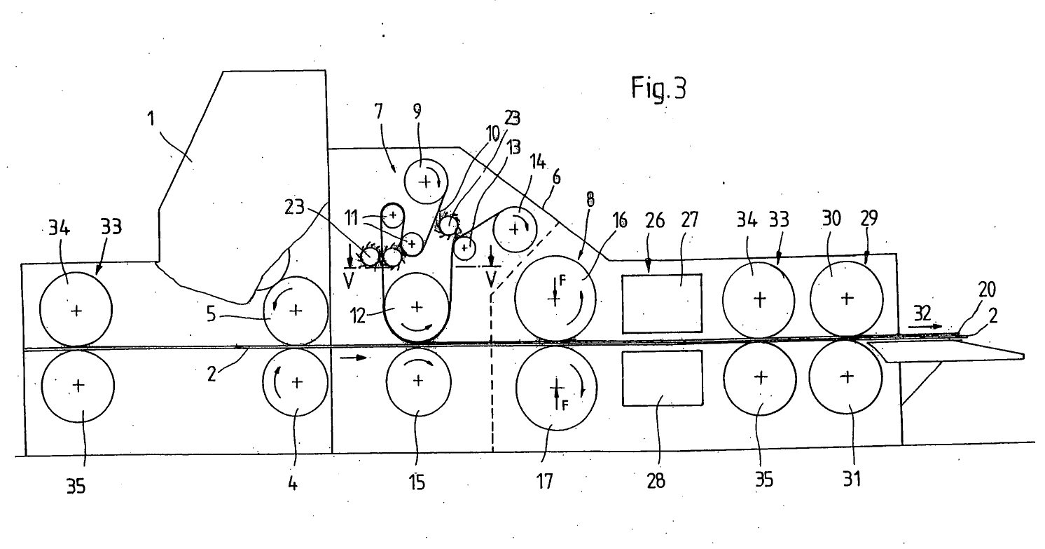

FIG. 3 is a simplified, partially cut side view showing a printing unit that can be integrated according to a third embodiment;

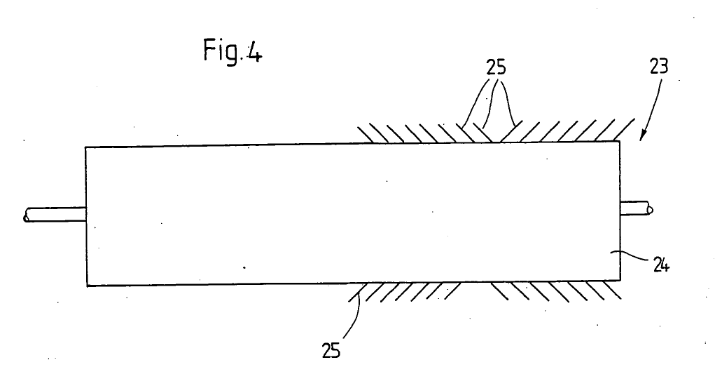

FIG. 4 is a partially cut side view of an asymmetrical expander roller;

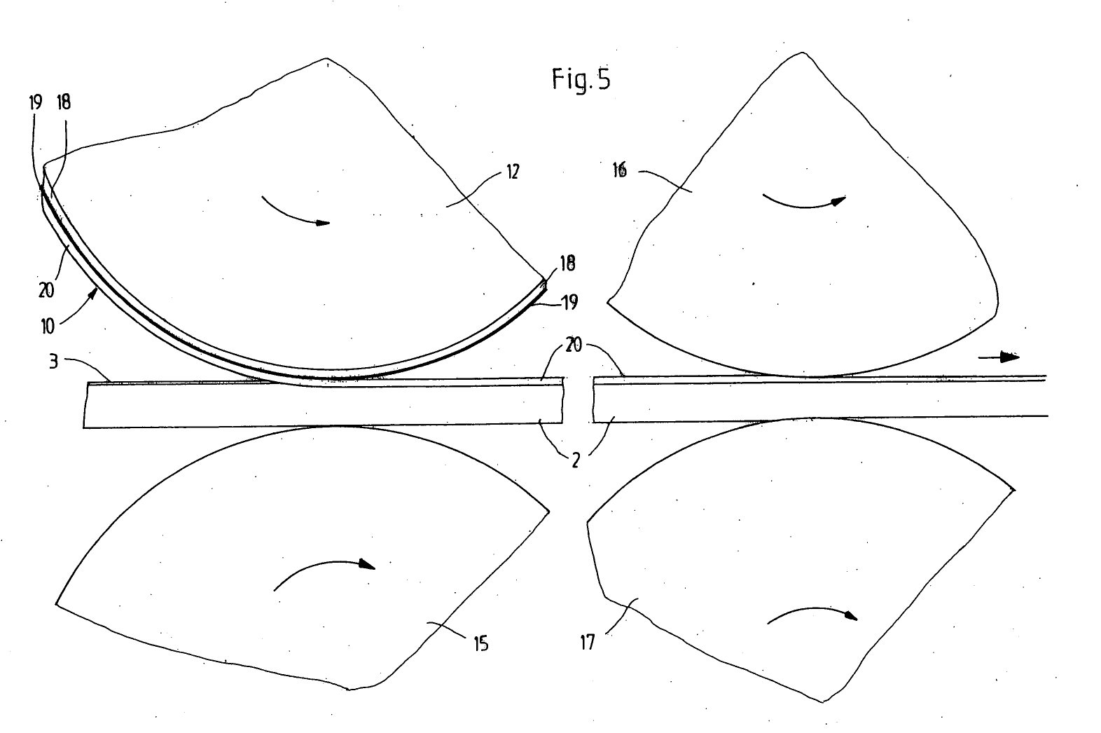

FIG. 5 is a shortened detailed view of a printing couple and of the pressing unit according to FIGS. 1 and 2 and

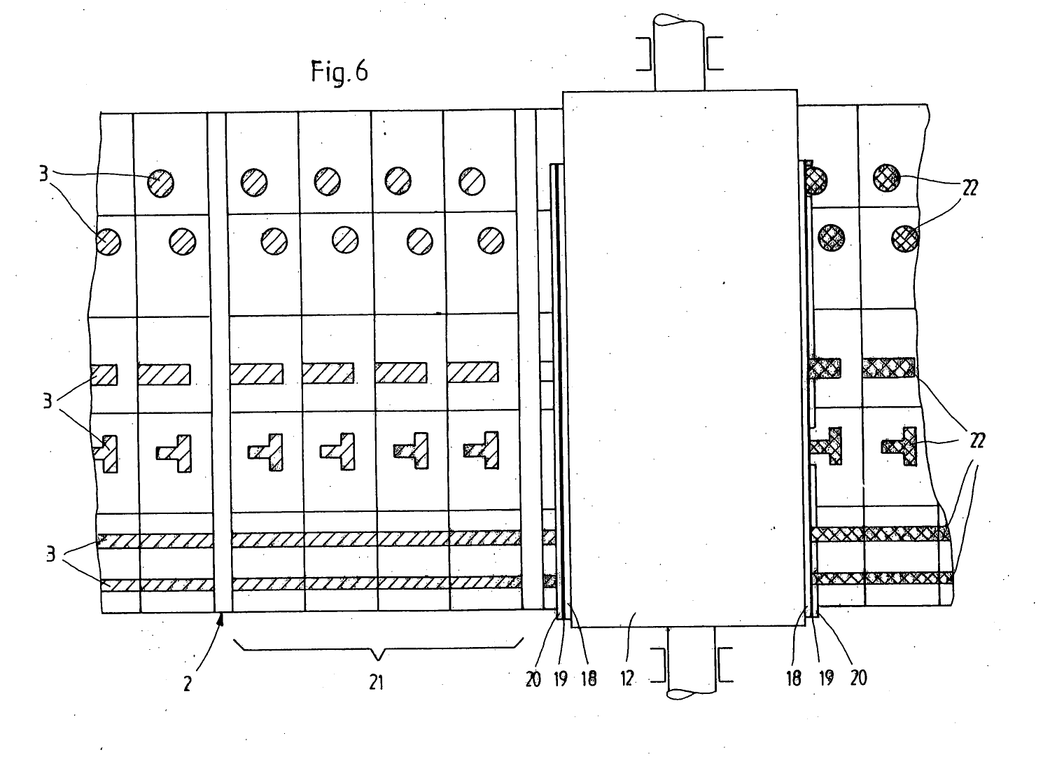

FIG. 6 is a partial view from above of the printing couple according to FIG. 4.

The printing unit represented in FIGS. 1, 2 and 3 is composed of several individual structural components. These components are the gluing unit 1, the transfer or printing unit 7, the pressing unit 8, the drying device 26, the printing device 29 of the structure and/or stamping calendars 33 as well as the flattening device formed by expander rollers 23.

The gluing unit 1 represented in the figures consists of a common two-colour printing couple, which within the scope of the invention serves for partially coating a base material 2 to be printed with a thin adhesive layer 3, for example a thin single- or two-component adhesive film. For this, the gluing unit 1 inter alia comprises a lower roller 4 as well as an upper roller 5, wherein the upper roller 5 serving as gluing organ can be a rubber blanket cylinder, which partially transfers the adhesive film according to a predetermined pattern to the base material 2, for example a paper or cardboard strip, which is guided through the gap between lower roller 4 and upper roller 5.

As represented in FIGS. 1, 2 and 3, gluing unit 1 is followed in the direction of transport 32 by the transfer or printing unit 7 and the pressing unit 8. In the shown exemplary embodiments both units are integrated in an installation and located in a housing 6. Herein, single stages, modular arrangements and the like can of course be realised, since the functional integrity is important and not the structural one.

In printing couple 7 a transfer film 10 winded up on a stock roll 9 is partially transferred to the base material 2 which is guided in a printing gap formed by two rollers through said printing couple 7. For this, the transfer film 10 is guided over two stretching rollers 11 towards a smooth-faced, eventually elastic printing roller 12 and finally reaches a collecting roll 14 via an intermediate roll 13. The printing roller 12 rolls with defined pressure on a chromium plated counter-roller 15 and forms together with this one a transfer calendar, while both rollers sandwich the base material 2 as well as the transfer film 10.

In the exemplary embodiments the optional pressing unit 8 is also formed by a calendar having two rollers, of which the upper roller is a smooth-faced pressing roller 16 and the lower roller is an also smooth-faced pressing counter-roller 17. The contact pressure generated between pressing roller 16 and pressing counter-roller 17 is considerably higher than the pressure between printing roller 12 and counter-roller 15.

According to a first alternative of the device which is represented in FIG. 1, a drying device 26, a printing device 29 and a structure and/or stamping calendar 33 are, in the direction of transport, placed upstream or downstream said pressing unit 8. In the transfer unit the film 10 is flattened in the direction of width by means of expander rollers 23. Due to the guidance of the rollers the film is flattened in longitudinal direction anyway. In this way it is assured that a flattened film carrier strip is introduced between printing roller 12 and counter-roller 15 for the transfer. An expander roller 23 can also be arranged in the carry-off zone in order to keep the film carrier flat for avoiding distortion or folding in the region of the printing roller. The base material 2 provided with the transfer layer 20 traverses the drying device 26 before reaching the printing device 29. By means of ventilator blowing or infrared radiation the base material 2 provided with the transfer layer 20 is dried in the drying device 26, which in particular serves for completely drying the adhesive layer 3 that has been previously applied on the base material 2. This drying operation is necessary in so far as in the following a printing of the base material 2 provided with a transfer layer 20 can be correctly carried out in-line, i.e. without intermediate storage of the base material 2 provided with a transfer layer 20. This printing operation is carried out in the printing device 29 that is placed downstream, in the direction of transport 32, the drying unit 26. This printing device 29 is preferably formed by an upper roller 30 and a lower roller 31, wherein preferably the surface 30 carries out the real printing of the base material 2, whereas the lower roller 31 is formed as counter-roller with respect to the upper roller 30 and serves for generating the counter-pressure that is required for the printing by the surface. The representation of inking units and other printing material guidings has been left out for reasons of clarity, since these ones are known from the state of the art.

A structure and/or stamping calendar 33 is arranged between drying unit 26 and printing device 29. This structure and/or stamping calendar 33 serves for providing the base material 2, that has previously been provided with a transfer layer 20 and has been dried, with a structure and/or stamping pattern. Following the stamping operation the base material 2 is printed by means of the printing device 29, as described above.

The structure and/or stamping calendar consists of a rubber cylinder 34 or of a steel cylinder, which serves as contact pressure roller, and of a structure and/or stamping roller 35, the surface of which carries the structure to be stamped into the base material 2 or the stamping pattern to be stamped into the base material 2 in negative form.

As furthermore shown in FIG. 1, the drying unit 26 is composed of an upper part 27 and of a lower part 28. The base material guided through the film transfer machine can thus be dried on both sides in one process step. Alternatively it can be provided that only one upper part 27 or only one lower part 28 is provided, but then it might be necessary for obtaining a satisfying drying process to design the drying device 26 with a corresponding length in the longitudinal direction, i.e. the direction of transport.

FIG. 2 shows a second embodiment of the printing unit according to the invention. In contrast to the exemplary embodiment according to FIG. 1 it is provided according to the exemplary embodiment of FIG. 2 that the base material 2 is printed before a transfer layer 20 is transferred from film 10 to the base material. For this purpose it is provided that the printing device 29 is placed upstream the gluing unit 1 in the direction of transport 32. Here, the base material 2 is printed in the above described manner, but in contrast to the exemplary embodiment according to FIG. 1 the base material has not yet been provided with a transfer layer 20. In order to assure a correct application of the adhesive agent 3 and a subsequent application of the transfer layer, a drying device 26 is placed immediately downstream the printing unit 29. The drying device is composed of an upper part 27 and a lower part 28, as already described above, wherein preferably an infrared drying or a drying by means of a ventilator is realized by the drying device. The printed and dried base material 2 is then supplied to the gluing unit 1 and in the following the transfer layer 20 is applied to the already printed base material 2 in the above described manner. Furthermore, expander rollers 23 are provided, which stretch the transfer layer 20 in the direction of width of the base material 2, in order to thus assure a correct forming of the transfer layer 20.

In contrast to the exemplary embodiment according to FIG. 1, it is furthermore provided according to the exemplary embodiment of FIG. 2 that the base material 2, which has to be printed and to be provided with a transfer film 20 in the following, is first provided with a stamping pattern, for which purpose a structure and/or stamping calendar 33 is placed upstream the printing device 29 in the direction of transport 32. The structure and/or stamping calendar 33 comprises, as already described above, a rubber cylinder 34 on the one hand and a structure and/or stamping roller 35 on the other hand. For reasons of a better clarity the other components of the structure and/or stamping calendar 33 have not been represented.

FIG. 3 shows another embodiment variant of the invention. According to this alternative, the structure and/or stamping calendar 33 is placed upstream the gluing unit 1. In the above described manner the transfer or printing unit 7, the pressing unit 8, the drying device 26 and the printing device 29 follow the gluing unit 1. Within the scope of an execution of the method according to the exemplary embodiment of FIG. 3, the base material 2 is first stamped. Then the adhesive agent 3 is applied which is followed by the application of the transfer film 20. Then the base material 2 provided with a transfer film 20 is dried and finally printed. The above described execution of the method is in particular suitable if the stamped patterns, which have been stamped into the base material 2 by means of the structure and/or stamping calendar 33, shall either be provided with a transfer film 20 or be printed in the following.

FIG. 4 shows an exemplary embodiment of an expander roller 23. The expander roller 23 is formed by a cylinder body 24, which is equipped with asymmetrically arranged lamella 25. The asymmetrical arrangement of the lamella 25 will be provided if only some areas of a base material are covered by a transfer film 20 or if only narrow base materials are printed. It goes without saying that the symmetry of the expander roller can be chosen according to the given conditions. Thus, half or quarter widths and the like, but also the use of only a central roller region and the like can be provided.

The application of the transfer film 10 within the printing unit is represented in the left part of FIG. 5. The transfer film 10, which only has a total thickness of about 12 μm, is composed of three layers in total. The most inner layer, which immediately sits on the printing roller 12, is a carrier foil 18, on which an adhesive base serving as parting layer 19 with a transfer layer 20 thereon is placed. Thus, the transfer layer 20 can be relatively easily detached from the carrier foil 18. The transfer layer 20 in turn mostly comprises two layers and consists of a thin, vacuum metallized aluminium layer and a for example coloured coat of lacquer. This two-layer structure of the transfer layer 20 is however not explicitly represented in the drawing.

When the film is applied, the base material 2 to be printed is passed with the circumferential speed of printing roller 12 or counter-roller 15 through the printing gap formed between these two rollers, wherein the transfer film 10 which is carried along on the blanket surface of the printing roller 12 is partially transferred to the base material 2. This transfer is exclusively realized at the points of base material 2 which have been provided with the adhesive layer 3 within the upstream gluing unit. The transfer film 10 is neither transferred as a whole to the base material 2, but exclusively the transfer layer 20 which can be easily detached from the carrier foil 18 will be transferred. Upon leaving the printing unit 7 the transfer layer 20 thus adheres to the base material 2 at the places which have previously been partly provided with the adhesive layer 3. The transfer layer 20 is for example a gold film, wherein the aluminium layer generates the metallising effect, whereas the golden colour is generated by the yellow- to ochre-coloured coat of lacquer.

For some applications it can be required to pass the base material 2 with the transfer layer 20 adhering thereto between the pressing roller 16 and the pressing counter-roller 17 of the pressing unit 8 of the calendar unit in order to give the film applied in the printing unit 7 the necessary permanency. In most of the cases this calendar unit can be omitted. While the pressure force in the printing unit 7 only has to be sufficient for assuring the film application, i.e. the transfer of the transfer layer 20 from the carrier foil 18 to the base material 2, the contact pressure which leads to a close connection between transfer layer 20 and base material 2 in the pressing unit. 8 is considerably higher.

The realization of the film application in the printing unit 7 is represented in FIG. 6 for a printing example. Within the scope of a continuous printing the base material 2 is respectively composed of a printing sheet 21 comprising 4×5 fields. For illustration the printing sheet 21 is provided with five different printing motives 22, which are repeated four times for every printing sheet 21. In the left part of FIG. 6, the printing sheets 21 are represented in the state before passing through the printing couple with the printing roller 12. In the region of the individual printing motives 22, the printing sheet 21 has already been provided with the partial adhesive layer 3. After leaving the printing roller 12 the printing sheets 21 are provided with the transfer layer 20 in the region of the partial adhesive layers 3 and thus form the completely applied printing motives 22. In the respective area of the printing motives 22 the transfer film 10, which sits on the printing roller 12, is lacking the transfer layer 20, as it is represented in the right part of FIG. 5.

Instead of the transfer film 10 represented in FIG. 6, which nearly extends over the entire width of the transfer calendar composed of printing roller 12 and counter-roller 15, also several individual transfer film strips can be used. This recommends itself in particular when the printing motives 22 are only distributed over a part of the strip width. For saving transfer film it is besides possible to at least temporally separate the transport of the transfer film from the transport of the base material by means of openings of the transfer calendar and to guide the transfer film clockwise. Several narrow film strips can also be used or the transfer calendar can be submitted to a clockwise pressure.

The printing motives 22, which are exemplarily represented in FIG. 6, can be stamped, as previously described with respect to FIGS. 1 through 3, i.e. they can be projecting or impressed with respect to the plane of base material 2.

The described exemplary embodiments only serve for explanation and are not limiting. The units according to the invention can in particular vary with respect to order, frequency of change-over between usual printing and film transfer and the like. Furthermore, it is within the scope of the invention that the use of a calendar after the film transfer is optional. This is only required if for example it has to be feared that the film swims on the adhesive or if another post-treatment becomes necessary.

### LIST OF REFERENCE NUMERALS

1 gluing unit
2 base material
3 adhesive layer
4 lower roller
5 upper roller
6 housing
7 transfer or printing couple
8 pressing unit
9 stock roll
10 transfer film
11 stretching roll
12 printing roller
13 intermediate roll
14 collecting roll
15 counter-roller
16 pressing roller
17 pressing counter-roller
18 carrier foil
19 parting layer
20 transfer layer
21 printing sheet
22 printing motives
23 expander roller
24 cylinder body
25 lamella
26 drying device
27 upper part
28 lower part
29 printing device
30 upper roller
31 lower roller
32 direction of transport
33 structure and/pr stamping calendar
34 rubber roller
35 structure and/or stamping roller

1. A method for the production of printed products by combining various immediately successive processing methods, wherein the printed products to be produced are coated with a film in predetermined positions in a film printing method in one step of the method and are provided with a structure and/or are stamped in another step of the method in a structure method and/or stamping method, wherein the printed products to be produced successively undergo the steps of the method without intermediate storage.

2. A method according to claim 1, wherein the printed products to be produced are first coated with a film and then provided with a structure and/or stamped.

3. A method according to claim 1, wherein the printed products to be produced are first provided with a structure and/or stamped and are then coated with a film.

4. A method according to claim 1 wherein, in another step of the methods the printed products to be produced are printed with color in a printing stage comprising at least one inking unit.

5. A method according to claim 1, wherein the printed products to be produced can be color printed before or after being coated with a film or before or after being stamped.

6. A method according to claim 1, wherein the printed products to be produced are dried in another step of the method, wherein the drying is carried out after the film coating and/or after the color printing.

7. A method according to claim 1, wherein a transfer film that has been supplied for the film printing method is stretched in the direction of width.

8. A method according to claim 7, wherein the stretching of the transfer film is only carried out in a region which corresponds to a partial area of the printing device.

9. A method according to claim 1, wherein the printed products to be produced are submitted to a pressing operation in another step of the method after the film coating.

10. A method according to claim 1, wherein the transfer film can be controlled with respect to the advance thereof with regard to the printing cylinder independently from the rotation thereof.

11. A device for carrying out the method according to claim 1, comprising at least one structure and/or stamping calender as well as at least one film transfer device.

12. A device according to claim 11, wherein at least one printing device comprising an inking unit.

13. A device according to claim 11 wherein a drying unit downstream the printing device and/or the film transfer device.

14. A device according to claim 11, wherein the film transfer device has at least one expander roller.

15. A device according to claim 14, wherein the expander roller is shorter than the width of the film transfer device.

16. A device according to claim 11, wherein the film transfer device comprises a calender.

17. A device according to claim 11, wherein the transfer film is guided over at least one roller having an axis that can be displaced in a transverse direction with respect to the sense of rotation.
